(19) United States
(12) Patent Application Publication
(10) Pub. No.: US 2024/0203270 A1
(43) Pub. Date: Jun. 20, 2024

(54) Method And System For Assisting The Avoidance Of A Collision With An Obstacle For An Aircraft Taxiing On An Aerodrome

(71) Applicant: Airbus Operation SAS, Toulouse (FR)

(72) Inventors: Emilie Claudel, Toulouse (FR); Isabelle Sentissi, Toulouse (FR); Louise Faure, Toulouse (FR)

(73) Assignee: Airbus Operation SAS, Toulouse (FR)

(21) Appl. No.: 18/535,117

(22) Filed: Dec. 11, 2023

(30) Foreign Application Priority Data
Dec. 16, 2022 (FR) 2213613

(51) Int. Cl. G08G 5/04; G08G 5/00; G08G 5/06

(52) U.S. Cl. CPC G08G 5/045; G08G 5/0021; G08G 5/0078; G08G 5/065

(57) ABSTRACT

The system includes a unit for monitoring the aerodrome so as to be able to detect at least one obstacle to determine a current relative position and a current relative speed of the aircraft (AC) with respect to the detected obstacle, and to detect a future or potential collision of the aircraft (AC) with the obstacle according to at least this current relative position and this current relative speed. The system also includes a unit for, in the event of detection of a future collision, implementing at least one action intended to help to avoid this future collision. The system is configured to provide assistance to the pilot of the aircraft by improving his awareness of the future collision, by means of warning messages and/or ground navigation aids, and by providing protection of last resort in the form of an automatic avoidance maneuver.

### FIELD OF THE INVENTION

The present invention relates to a method and a system for assisting the avoidance of a collision with an obstacle for an aircraft taxiing on an aerodrome.

Within the scope of the present invention:
“collision” is understood to mean physical contact between the aircraft and another object (or physical entity) that is mobile or immobile, moving or is located on the aerodrome. Within the scope of the present invention, an object can be a material element located on the aerodrome (notably such as an infrastructure element of the aerodrome or a machine) or a living being (such as an animal or a human being) located on the aerodrome;
“obstacle” is understood to mean an object that presents a risk of collision with the aircraft.

### BACKGROUND OF THE INVENTION

Currently, no certified function fully assists the pilot of an aircraft taxiing on an aerodrome in monitoring such obstacles presenting a risk of collision with the aircraft.

However, when taxiing on the aerodrome, the pilot must carry out tasks and checks that notably involve them looking at head-down displays in the cockpit, which makes it difficult for them to continuously look outside the aircraft in order to continuously monitor all the objects that could become such obstacles.

### BRIEF SUMMARY OF THE INVENTION

Furthermore, it could be worthwhile having a solution available for assisting a pilot of an aircraft taxiing on an aerodrome in detecting obstacles, in order to make it easier for them to monitor and to assist them in the avoidance of a potential collision.

An aspect of the present invention may provide such a solution. To this end, an aspect of the present invention relates to a method for assisting the avoidance of a collision with an obstacle (namely a mobile object or an immobile object) for an aircraft taxiing on an aerodrome.

According to an aspect of the invention, said method comprises at least the following steps:
a monitoring step, implemented by a monitoring unit, at least for monitoring the aerodrome so as to be able to detect at least one obstacle, for determining a current relative position and a current relative speed of the aircraft relative to the detected obstacle, and for detecting a future collision of the aircraft with the obstacle as a function of at least this current relative position and this current relative speed; and
an avoidance assistance step, implemented by at least one avoidance assistance unit, at least in order to implement, in the event of the detection of a future collision in the monitoring step, at least one action intended for assisting the avoidance of (i.e., prevent) the future collision.

Thus, the method is able, on the one hand, to detect a future collision, with an obstacle, namely a mobile or immobile object, by the aircraft on which said method is implemented, and, on the other hand, to assist the pilot of the aircraft to avoid the collision in such a situation, and particularly so doing, as specified below, by improving the awareness of the pilot with respect to the actual situation (by means of warning or ground navigation assistance messages) and/or by providing last-resort protection (namely by forcing the aircraft into an automatic avoidance maneuver).

Within the scope of the present invention, future collision (or potential collision) is understood to mean a risk of collision of the aircraft with an obstacle, which will occur if the current relative movement conditions between the aircraft and this obstacle are maintained as such.

Advantageously, the monitoring step comprises a first data receiving step implemented for receiving data on the external environment of the aircraft and a data processing step implemented for processing the data received in the first data receiving step so as to detect, if applicable, an obstacle, for determining the current relative position and the current relative speed of the aircraft relative to the detected obstacle, and for detecting a future collision.

In addition, advantageously, the first data receiving step receives data on the external environment of the aircraft from at least one of the data sources of a first set, said first set comprising at least some of the following data sources of the aircraft:
an optical detection device;
a radar;
a lidar;
a cooperative surveillance system.

Moreover, advantageously, the data processing step implements a data merging operation received from at least two different data sources of said first set in order to consolidate the data used for detecting an obstacle.

Furthermore, in a particular embodiment, the monitoring step comprises a second data receiving step implemented for receiving position data of the aircraft and a data processing step implemented for processing the position data received in the second data receiving step so as to determine a position, called absolute position, of the aircraft and for comparing this absolute position of the aircraft with an absolute position of at least one fixed object of the aerodrome in order to detect, if applicable, a future collision with this fixed object representing an obstacle.

In addition, advantageously, the second data receiving step receives position data from at least one of the data sources of a second set, said second set comprising at least some of the following data sources of the aircraft:
an inertial reference system;
a satellite positioning system;
an odometer,
a tachometer.
an optoelectronic sensor.

Moreover, advantageously, the data processing step implements an operation of merging position data received from at least two different data sources of said second set for determining a consolidated absolute position of the aircraft.

Furthermore, in a particular embodiment, the monitoring step comprises a data processing step implemented for determining at least one current warning envelope corresponding to a time, called collision time, at least depending on said current relative position, on the current relative speed and on parameters of the aircraft, and for detecting a future collision with a detected obstacle if the current warning envelope touches this detected obstacle.

Advantageously, the current warning envelope assumes a shape reproducing, in a simplified manner, a front part of an external contour of the aircraft, and it is positioned in front of the aircraft at a corresponding distance.

Moreover, advantageously, the avoidance assistance step is implemented for emitting at least one of the following messages in the cockpit of the aircraft: a warning message, a ground navigation assistance message, said message being emitted in at least one of the following forms: visual, audible.

In addition, advantageously, the avoidance assistance step is implemented for forcing the aircraft into an automatic avoidance maneuver, for example, automatic braking, at least in the absence of appropriate action by the pilot after the emission of at least one message.

The present invention also relates to a system for assisting the avoidance of a collision with an obstacle (namely a mobile object or an immobile object) for an aircraft taxiing on an aerodrome.

According to the invention, said system (which is intended to be mounted on the aircraft) comprises at least:
a monitoring unit configured for monitoring the aerodrome so as to be able to detect at least one obstacle, for determining a current relative position and a current relative speed of the aircraft relative to the detected obstacle, and for detecting a future collision of the aircraft with the object as a function of at least this current relative position and this current relative speed; and
an avoidance assistance unit configured for, in the event of the detection of a future collision by the monitoring unit, implementing at least one action intended for assisting the avoidance of the future collision.

The present invention also relates to an aircraft, in particular a transport aircraft, which comprises at least one system for assisting the avoidance of a collision with an obstacle as described above.

### BRIEF DESCRIPTION OF THE FIGURES

The appended figures will clearly demonstrate how the invention can be implemented. In these figures, identical reference signs denote similar elements.

FIG. 1 is the block diagram of a system for assisting the avoidance of a collision with an obstacle, according to a particular embodiment of the invention.

FIG. 2 is a schematic perspective view of part of an aerodrome on which an aircraft equipped with a system for assisting the avoidance of a collision with an obstacle is taxiing.

FIG. 3 schematically illustrates the main steps of a method for assisting the avoidance of a collision with an obstacle, according to a particular embodiment of the invention.

FIG. 4 is a schematic view of an aircraft as seen from above, in relation to which various envelopes, called warning envelopes, have been shown.

### DETAILED DESCRIPTION

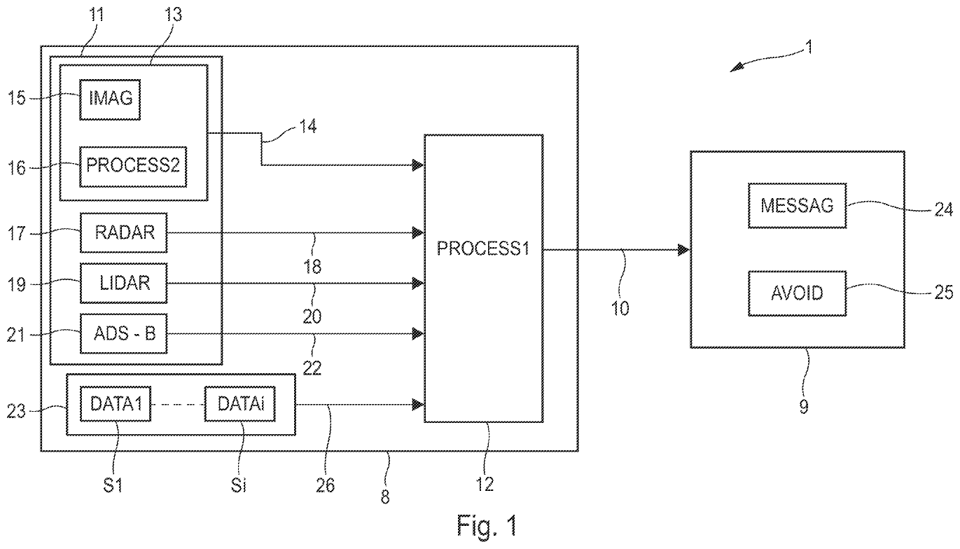

The system 1, schematically shown in FIG. 1, which illustrates the invention, is an anti-collision system intended to equip an aircraft AC, in particular a transport aircraft.

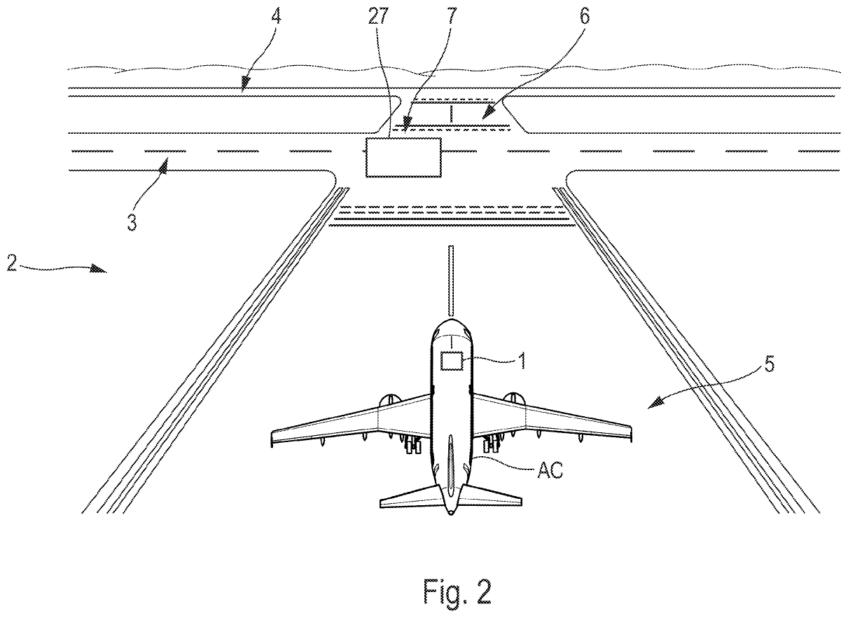

This system 1 (which is on board the aircraft AC, as is highly schematically shown in FIG. 2 and FIG. 4) is intended to assist the aircraft AC, when it is taxiing on an aerodrome 2, as in the example shown in FIG. 2, to avoid a collision with an obstacle 7, namely a mobile object or an immobile object, as specified below.

As shown by way of an illustration in FIG. 2, the aerodrome 2 comprises taxiways notably comprising:
runways 3 and 4 intended for aircraft take-off and/or landing; and
taxiways 5 and 6 allowing an aircraft to taxi on the aerodrome 2, notably in order to travel (by taxiing) between the runway 3, 4 used for take-off or landing and a parking area (not shown).

In the example shown in FIG. 2, the aircraft AC is taxiing on the taxiway 5 toward the runway 3.

Said (anti-collision) system 1 comprises, as shown in FIG. 1:
a monitoring unit 8 configured:
   to monitor the aerodrome 2 so as to be able to detect at least one obstacle 7 (FIG. 2);
   to determine the current relative position and the current relative speed of the aircraft AC relative to a detected obstacle 7; and
   to detect a future collision of the aircraft AC with the obstacle 7 as a function of at least this current relative position and this current relative speed; and
an avoidance assistance unit 9, connected to the monitoring unit 8 via a link 10 and configured in order to implement, in the event of the detection of a future collision by the monitoring unit 8, at least one action intended to assist the avoidance of this future collision.

The monitoring unit 8 comprises a set 11 of data sources allowing the system 1 to receive data on the external environment of the aircraft AC. The set 11 comprises data sources, specified below, that are generally already fitted on the aircraft AC.

The monitoring unit 8 also comprises a data processing device 16 (PROCESS1) configured to carry out the various processes and computations, described below. The data processing device 12 is connected to the various data sources of the set 11.

In a particular embodiment, the set 11 comprises an optical detection system 13, preferably a visual detection system. This optical detection system 13, which is connected to the data processing device 12 via a link 14, comprises, as shown in FIG. 1:
an imaging device 15 (IMAG) configured to take images of the external environment of the aircraft AC; and
an image processing device 16 (PROCESS2) configured to process at least some of the images taken by the imaging device 15 so as to detect, if applicable, an obstacle (specified below), when this obstacle is shown on at least one of the processed images (i.e., a representation of which is found on the image).

Preferably, the imaging device 15 takes images in the visible spectrum and the optical detection system 13 then corresponds to a visual detection system. As an alternative embodiment, it can also take images from radiation with other wavelengths, for example, in the infrared spectrum, notably in the event of limited external visibility.

Moreover, the image processing device 16 implements at least one of the following techniques, described hereafter:
a technique using artificial intelligence;
an image processing technique.

The set 11 also comprises a radar 17 (RADAR “Radio Detection and Ranging”) that is connected to the data processing device 12 via a link 18. The radar 18 can conventionally provide distance and speed information that can be used to detect and locate obstacles.

Moreover, the set 11 also comprises a lidar 19 (LIDAR “Light Detection and Ranging”) that is connected to the data processing device 12 via a link 20. The lidar 19 is an alternative or additional data source to the radar 17, for providing relative distance data and the geometry of the detected obstacles. In addition, the lidar 19 is also conventionally able to provide information or data that allows obstacles to be detected and located.

Moreover, in a particular embodiment, the set 11 also comprises a cooperative surveillance system 21 of the ADS-B (“Automatic Dependent Surveillance-Broadcast”) type, which is connected to the data processing device 12 via a link 22 and represents an additional data source. Commercial transport aircraft are known to continuously broadcast information or data (for example, the position, the speed and the call sign) pertaining to them using this ADS-B type cooperative surveillance system 21. Some land vehicles that travel on the aerodrome 2 also broadcast this type of information. Consequently, all the movable craft, aircraft or other land vehicles that travel on the aerodrome 2 and are equipped with a cooperative surveillance system 21 receive the position and speed information broadcast by the other users of said cooperative surveillance system 21. Consequently, it is a direct data source of information concerning the surrounding objects. The cooperative monitoring system 21 thus notably provides an absolute position for each user.

In a particular embodiment, the data processing device 12 implements a data merging operation. This data merging operation merges the data received from at least two different data sources of the set 11 in order to consolidate this data, which is then used by the data processing device 12 to detect an obstacle, which allows the accuracy, the reliability and the obstacle detection speed of the (anti-collision) system 1 to be improved.

Furthermore, in a particular embodiment, the monitoring unit 8 also comprises a set 23 of data sources S1, . . . , Si (DATA1, . . . , DATAi), with i being an integer. This set 23 comprises at least one of the following conventional data sources S1 to Si, generally fitted on the aircraft AC:
an inertial reference system;
a satellite positioning system;
an odometer,
a tachometer,
an optoelectronic sensor.

In addition, the data processing device 12, which is connected to the set 23 via a link 26, is notably configured to process data, called position data, supplied by at least one (and preferably a plurality) of said data sources S1 to Si of the set 23. The data processing device 12 conventionally processes this position data in order to determine a position, called absolute position, of the aircraft.

The data processing device 12 is also configured to compare this absolute position of the aircraft with the absolute position of at least one fixed object of the aerodrome, taken, for example, from an aerodrome database or determined elsewhere. If applicable, such a comparison allows a future collision with this fixed object to be detected, which in this case represents an obstacle.

Preferably, the data processing device 12 implements a data merging operation. This data merging operation merges position data received from at least two different data sources S1, . . . , Si of the set 23 in order to determine a consolidated absolute position of the aircraft AC, i.e., a particularly precise absolute position.

Furthermore, in a particular embodiment, the data processing device 12 is configured to determine at least one current warning envelope A1, A2, A3 (FIG. 4) corresponding to a time, called collision time, and at least depending on said current relative position and on parameters of the aircraft AC, and to detect a future collision with a detected obstacle 7 if the warning envelope A1, A2, A3 touches this detected obstacle 7.

Furthermore, the avoidance assistance unit 9 comprises a message emitting device 24 (MESSAG). The message emitting device 24 is configured to emit, in the cockpit of the aircraft AC and to the pilot or pilots of the aircraft AC, at least one warning message and/or at least one ground navigation assistance message. The message emitting device 24 emits the one or more messages in visual form and/or in audible form and/or in any other form such as, for example, a mechanical stimulation in the seat of the pilot.

In addition, the avoidance assistance unit 9 also comprises an automatic avoidance device 25 (AVOID) configured to automatically generate an avoidance maneuver, notably braking, for the aircraft AC, in the absence of appropriate action by the pilot after a (collision) warning message has been emitted by the message emitting device 24.

Thus, as will be described in further detail below, the system 1 is able, on the one hand, to detect a future collision, i.e., a potential collision, with an obstacle 7, namely a mobile or immobile object, by the aircraft AC equipped with the system 1, and, on the other hand, to assist the pilot of the aircraft AC to avoid the collision in such a situation, and particularly so doing, as is also specified below, by improving the awareness of the pilot with respect to the actual situation (by means of warning and/or ground navigation assistance messages, emitted by the message emitting device 24) and/or by providing last-resort protection (or a safeguard) (by an automatic avoidance maneuver, notably automatic braking, implemented by the automatic avoidance device 25).

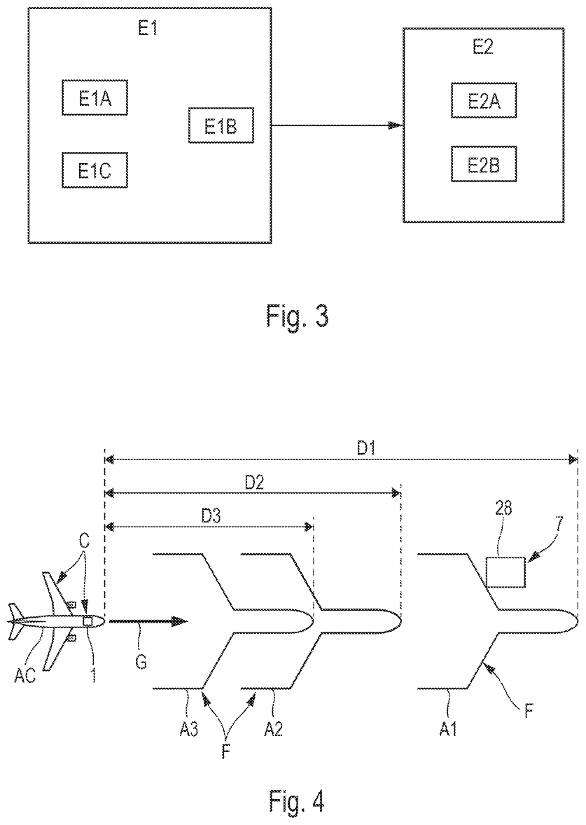

The system 1, as described above, is intended to implement a method P for assisting the avoidance of a future collision with an obstacle 7 by an aircraft AC taxiing on an aerodrome 2 (FIG. 2), as shown below with reference to FIG. 3.

The method P comprises the following steps:
a monitoring step E1, implemented by a monitoring unit 8, at least for monitoring the aerodrome 2 so as to be able to detect at least one obstacle 7, for determining the current relative position and the current relative speed of the aircraft AC relative to the detected obstacle 7, and for detecting a future collision of the aircraft AC with the obstacle 7 as a function of at least this current relative position and this current relative speed; and
an avoidance assistance step E2, implemented by the avoidance assistance unit 9, at least in order to implement, in the event of the detection of a future collision in the monitoring step E1, at least one action intended for assisting the avoidance of the future collision.

Within the scope of the present invention, the obstacle 7 can be a mobile object or an immobile object. The mobile object 27, as is highly schematically shown in FIG. 2, can be any type of movable craft, such as an aircraft or a land vehicle moving on the aerodrome 2. In the example shown in FIG. 2, the object 27 is moving along the runway 3 that the aircraft AC is joining. Moreover, an immobile object 28, as is highly schematically shown in FIG. 4, can be a fixed object such as an infrastructure element of the aerodrome 2 or a movable craft such as a land vehicle or an aircraft that is stationary on the aerodrome 2, for example, on a taxiway.

By way of a non-limiting illustration, the main types of object likely to be potential obstacles, which can be encountered on the surface area of the aerodrome 2 and which can be detected by the system 1, notably are as follows:
a building, notably a hangar,
an air bridge;
a retractable staircase;
scaffolding;
signage;
a lighting mast;
a crane;
part of a parked, stationary or even moving aircraft (in particular its vertical tail fin, its horizontal tail fin, its tail, a tip of one of its wings and its nose);
a land vehicle;
an aerodrome service vehicle (re-fueling, supply, etc.);
a flock of birds;
a pedestrian;
a small object (part of an aircraft, etc.);
a land animal;
a blast-proof fence.

The monitoring step E1 comprises a data receiving step E1A implemented for receiving data on the external environment of the aircraft AC and a data processing step E1B implemented for processing the data received in the data receiving step E1A so as to detect, if applicable, an obstacle 7, for determining the current relative position and the current relative speed of the aircraft AC relative to the detected obstacle 7, and for detecting a future collision.

In the data receiving step E1A, the system 1 receives data on the external environment of the aircraft AC from at least one of the aforementioned data sources of the set 11 (FIG. 1) of the aircraft AC, namely:
the optical detection device 13;
the radar 17;
the lidar 19;
the cooperative surveillance system 21.

In a preferred embodiment, the monitoring step E1 thus comprises an optical detection step implemented by the optical detection device 13. This optical detection step comprises:
an image-taking sub-step, implemented by the imaging device 15, for taking images of the external environment of the aircraft AC. The imaging device 15 conventionally provides 2D images of the scene outside and in front of the aircraft AC, in the visible spectrum or in the infrared spectrum (notably in the event of low visibility); and
an image processing sub-step, implemented by the image processing device 16, for processing at least some of the images taken in said image taking sub-step so as to detect, if applicable, an object (mobile or immobile) likely to be an obstacle, when this object is shown on at least one of the processed images.

The optical detection step is implemented to detect all the (visual) objects that are likely to be considered to be obstacles and to be taken into account when implementing the monitoring step E1.

In order to implement the optical detection step, the aircraft AC is equipped with one or more imaging devices 15, namely, preferably, cameras, for taking (or capturing) images of the external environment (in the image-taking sub-step) while the aircraft AC is taxiing and to supply the image-processing device 16 with the captured images. The cameras can be arranged at various locations on the aircraft, for example, on a belly fairing, on the fin, on the nose and/or on the sides of the aircraft fuselage.

In a first alternative embodiment, the image processing sub-step implements a technique using artificial intelligence. Various artificial intelligence approaches can be used, including machine learning and/or deep learning techniques.

In a preferred embodiment, in which the image processing device 16 is based on artificial intelligence using a machine learning system, the machine learning system uses, for learning purposes, previously gathered data that represents various situations consistent with those that can be encountered by an aircraft taxiing on an aerodrome. To this end, cameras are installed on one or more aircraft. These cameras are identical to those used by the system 1 or at the very least have technical features similar to those used by the system 1. In addition, these cameras are installed on this aircraft or these aircraft at the same locations as those of the cameras of the system 1, or at locations as close as possible to them. Images are taken as the one or more aircraft thus equipped are taxiing on aerodromes, and the captured images are stored. All the stored images are then gathered. The captured images are taken on different aerodromes, for different and varied lighting conditions (for example, daytime, nighttime, etc.) and different and varied weather conditions (for example, sunny, rainy, snowy, etc.) so as to take into account all the main situations and conditions likely to be encountered by an aircraft equipped with the system 1. All the images thus gathered are used by the artificial intelligence learning system of the image processing device 16 in order to help it to recognize the objects sought in the images taken by the imaging device 15.

Various processing techniques based on artificial intelligence can provide the required information. The following can be cited by way of an illustration:
object detection. In this case, if an object is shown in the image, the artificial intelligence algorithm detects it and spatially locates it in the image;
image segmentation. In this case, each pixel in the image is classified as to whether or not it forms part of an object, and if an object is shown in the image, all the pixels relating to this object allow it to be detected and located.

In a second alternative embodiment, the image processing sub-step implements an image processing technique.

It is known that image processing techniques process the pixels of the image using filters and conventional signal processing techniques, in order to recover points of interest and geometric information in the image in order to check whether an object is shown in the image, and, if applicable, to spatially locate it in the image.

Moreover, in a third alternative embodiment, the image processing sub-step implements both a technique (such as that described above) using artificial intelligence and an image processing technique (such as that also described above).

Calibration of the imaging device 15 (intrinsic and extrinsic parameters) then allows the image processing device 16 of the system 1 to determine the relative position of the aircraft AC relative to the detected obstacle 7.

By virtue of taking successive images and estimating the successive relative positions of the aircraft AC, the image processing device 16 is also able to determine the relative speed of the aircraft AC relative to the detected obstacle 7.

For an obstacle further away from the aircraft AC, optical detection using the optical detection system 13 may not be accurate enough for estimating the distance of the obstacle from the aircraft AC.

Also, in addition to or as an alternative embodiment of the optical detection step, the system 1 uses, in the data receiving step E1A, the radar 17 that provides distance information with sufficient accuracy for the system 1. In addition, with signal processing, the radar 17 also represents a useful source of information for detecting and locating obstacles.

Moreover, in addition or as an alternative embodiment, the system 1 can also use, in the data receiving step E1A, the lidar 19, which is an alternative to the radar 17, to provide relative distance information as well as the geometry of the detected obstacles. In addition, with signal processing, the lidar 19 is also a useful source of information for detecting and locating obstacles.

Furthermore, in addition to or as an alternative embodiment to one or more of the aforementioned data sources 13, 17 and 19, the data receiving step E1A can also use the ADS-B (Automatic Dependent Surveillance-Broadcast) type cooperative surveillance system 21. This cooperative surveillance system 21 is a direct data source providing position and speed data for surrounding objects equipped with such a system. The cooperative surveillance system 21 provides an absolute position of each user (notably the aircraft and some land vehicles). Being aware of, on the one hand, the absolute position of the aircraft AC and, on the other hand, the absolute position of an obstacle 7, allows the data processing device 12 to determine the relative position of the aircraft AC relative to said obstacle 7.

Furthermore, in a preferred embodiment, the data processing step E1B implements a data merging operation. This data merging operation merges, using a conventional data merging algorithm, the data received from at least two different data sources of the set 11 in the data receiving step E1A. This conventional type of data merging operation allows the data used to detect an obstacle to be consolidated. This allows the accuracy and the reliability of the detection to be increased.

Furthermore, in a particular embodiment, the monitoring step E1 also comprises a data receiving step E1C implemented for receiving position data of the aircraft AC, from at least one of the data sources S1 to Si of the set 23 (FIG. 1).

Preferably, in the second data receiving step E1C, the system 1 receives position data from at least one of the following data sources of the set 23 of the aircraft AC:
an inertial reference system;
a satellite positioning system;
an odometer,
a tachometer,
an optoelectronic sensor.

In a particular embodiment, the data processing step E1B:
processes the position data received in the data receiving step E1C so as to determine an absolute position of the aircraft AC, i.e., a position of the aircraft AC on the aerodrome 2, clearly defined as such; and
compares this absolute position of the aircraft AC with an absolute position of at least one fixed object on the aerodrome 2, such as, for example, the object 28 in FIG. 4, in order to detect, if applicable, a future collision with this fixed object 28, which then represents an obstacle 7.

Moreover, in a preferred embodiment, the data processing step E1B implements a data merging operation. This data merging operation merges, using a conventional data merging algorithm, the data received from at least two different data sources of the set 23, in the data receiving step E1C. This conventional type of data merging operation allows the received data to be consolidated and the data thus consolidated to be used to detect an obstacle, which allows the accuracy and the reliability of the detection to be increased.

Furthermore, the data processing step E1B, implemented by the data processing device 12, also carries out the following operations:
determining at least one current warning envelope A1, A2, A3 (FIG. 4) corresponding to a time, called collision time, and at least depending on said current relative position and on parameters of the aircraft AC; and
detecting a future collision with a detected obstacle 7 if the current warning envelope A1, A2, A3 touches this detected obstacle 7.

In a particular embodiment, three warning levels are provided, namely in the order for triggering the warning in the event of a risk of collision:
an optional “advisory” indication;
a caution; and
a warning.

A current warning (or safety) envelope A1, A2, A3 is determined for each of the considered warning levels. More specifically, in the aforementioned particular embodiment, as shown in FIG. 4:
warning envelope A1 is determined for the advisory;
warning envelope A2 is determined for the caution;
warning envelope A3 is determined for the warning.

In the preferred embodiment, shown in FIG. 4, each warning envelope A1, A2, A3 assumes a simplified shape F reproducing the front part of the external contour C of the aircraft AC. The front of the aircraft AC is defined in the direction and the sense of movement of the aircraft AC, as indicated by an arrow G in FIG. 4, and each warning envelope A1, A2, A3 is positioned in front of the aircraft AC at a particular distance D1, D2, D3 therefrom. This distance D1, D2, D3 represents the relative distance between the aircraft AC and an obstacle 7 from which the corresponding warning will be triggered. The simplified shape F can assume a segmented shape (acquired from adjacent segments), partly comprising, for example, flat adjacent surfaces.

This particular shape F of the warning envelopes A1, A2, A3 (reproducing, in a simplified way, the front part of the external contour C of the aircraft AC) allows the obstacle detection to be adapted (in a simplified manner) to the particular shape of the aircraft and thus allows all the parts of the aircraft to be taken into account and notably those that are most exposed to a collision. The ground anti-collision function implemented by the system 1, which uses warning envelopes A1, A2, A3 adapted to the front external contour C of the aircraft AC, thus allows the aircraft AC to be protected against collisions, notably for the following parts of said aircraft AC, which are generally the most exposed:
the wingtips;
the engine nacelles;
the nose;
the horizontal tail fin; and
the vertical tail fin.

The distance D1, D2, D3 is computed as a function of a time, called collision time. The collision time is a predetermined time. It corresponds to the duration to allow the aircraft AC to reach the obstacle 7 before triggering the corresponding warning. It increases as a function of the warning level, as shown in FIG. 4 for the corresponding distances D1, D2 and D3. By way of a non-limiting illustration, it can be, for example, 3 or 4 seconds for the distance D3, 5 or 6 seconds for the distance D2, and 8 to 10 seconds for the distance D1.

The distance D3 is computed (by the data processing device 12) as a function of the corresponding predetermined collision time, taking into account the following parameters comprising parameters of the aircraft AC:
the current relative trajectory (relative position and relative speed) of the obstacle 7 relative to the aircraft AC;
parameters (speed, braking capacities) of the aircraft AC; and
any deceleration order generated on the aircraft AC.

With respect to the distances D2 and D1, these are computed from the distance D3, each time taking into account a corresponding predetermined pilot reaction and decision-making time.

Finally, the avoidance assistance step E2, implemented by the avoidance assistance unit 9, carries out (in the case of a future collision deduced in the monitoring step E1) at least one action intended to assist the avoidance (i.e., prevent) of this future collision.

To this end, the avoidance assistance step E2 generally firstly comprises a sub-step E2A of emitting one or more messages to the pilot in the cockpit of the aircraft AC. The one or more messages can be one or more warning messages (simply warning the pilot of the situation) and/or one or more ground navigation assistance messages (providing the pilot with indications or instructions for addressing the risk of collision, for example, by asking the pilot to brake or change the direction of the aircraft AC).

The message emitting device 24 emits this message or these messages:
in visual form, for example, by displaying a message or a sign on a cockpit screen, notably via a head-up display, or by emitting a light signal; and/or
in audible form, for example, using a loudspeaker or a siren installed in the cockpit.

Each emitted warning message depends on the considered warning level, from among the possible warning levels, and notably from among the three warning levels described above. By way of an illustration, for these three warning levels, the message emitting device 24 can emit the following messages:
for an advisory, a visual message;
for a caution, visual and audible messages;
for a warning, visual and audible messages, and, if necessary, an automatic avoidance sub-step E2B is triggered.

By way of an illustration, in the example shown in FIG. 4, the envelope A1 (relating to an “advisory”), which assumes the shape F, which is positioned at the distance D1 in front of the aircraft AC and which therefore moves forward (in the direction of the arrow G) as the aircraft AC is taxiing on the ground, has just touched the obstacle 7 (corresponding, for example, to an immobile object 28). This obstacle 7 is then detected by the system 1, which triggers the corresponding warning, namely the message emitting device 24 emitting a visual message in the aircraft cockpit that corresponds to this warning level (“advisory”).

Furthermore, the sub-step E2B involves carrying out an automatic avoidance maneuver of the aircraft AC, which is implemented by the automatic avoidance device 25. To this end, in a particular embodiment, the automatic avoidance device 25 automatically sends a control order to a conventional control system of the aircraft AC, which causes the aircraft AC to carry out the avoidance maneuver. In a particular embodiment, the control order is a braking order.

Consequently, if, following the advisory, caution and warning alerts, the pilot does not take the appropriate measures, the system 1 triggers an avoidance action or maneuver involving implementing a maneuver for automatically avoiding the obstacle 7 using the automatic avoidance device 25. The avoidance maneuver can involve causing the aircraft AC to change taxiing direction in order to avoid or bypass the obstacle 7, or can involve braking the aircraft AC. In the latter case, an appropriate automatic braking order is computed and sent to a conventional braking system of the aircraft in order to stop it and thus prevent the collision.

This sub-step E2B thus implements last-resort protection, by allowing the system 1 to automatically carry out an avoidance maneuver instead of the pilot.

In a particular case, if the necessary conditions are met, this sub-step E2B can be implemented, even if sub-step E2A has not been implemented beforehand.

The system 1 and the method P, as described above, that implement a ground anti-collision function, have numerous advantages. In particular:
they are able to automatically detect a future collision or potential collision with a mobile or immobile obstacle by the aircraft equipped with the system 1;
they can provide assistance to the aircraft pilot in order to avoid the collision in such a situation;
this assistance firstly involves making the pilot aware of the actual situation and optionally of the actions to be taken (using one or more warning and/or ground navigation assistance messages);
this assistance notably allows the pilot to be provided with a relevant warning level as a function of the collision time; and
this assistance also includes last-resort protection (by implementing an automatic avoidance maneuver, and notably automatic braking).

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for assisting the avoidance of a collision with an obstacle for an aircraft taxiing on an aerodrome, said method comprising:
a monitoring step (E1), implemented by a monitoring unit (8), at least for monitoring the aerodrome so as to be able to detect at least one obstacle, for determining a current relative position and a current relative speed of the aircraft relative to the at least one detected obstacle, and for detecting a future collision of the aircraft with the at least one obstacle as a function of at least the current relative position and the current relative speed, the monitoring step (E1) comprising a data processing step (E1B) implemented for determining at least one current warning envelope corresponding to a time, called collision time, and at least depending on said current relative position, on the current relative speed and on parameters of the aircraft, and for detecting a future collision with the at least one detected obstacle if the current warning envelope touches the at least one detected obstacle, the current warning envelope assuming a shape reproducing, in a simplified manner, a front part of an external contour of the aircraft, and the current warning envelope is positioned in front of the aircraft at a corresponding distance; and
an avoidance assistance step (E2), implemented by at least one avoidance assistance unit, at least in order to implement, in the event of the detection of a future collision in the monitoring step (E1), at least one action configured for assisting the avoidance of the future collision.

2. The method as claimed in claim 1,
wherein the monitoring step (E1) comprises a first data receiving step (E1A) implemented for receiving data on the external environment of the aircraft and a data processing step (E1B) implemented for processing the data received in the first data receiving step (E1A) so as to detect, if applicable, an obstacle, for determining the current relative position and the current relative speed of the aircraft relative to the detected obstacle, and for detecting a future collision.

3. The method as claimed in claim 2,
wherein the first data receiving step (E1A) receives data on the external environment of the aircraft from at least one of the data sources of a first set, said first set comprising at least one of the following data sources of the aircraft:
an optical detection device;
a radar,
a lidar; or
a cooperative surveillance system.

4. The method as claimed in claim 3,
wherein the data processing step (E1B) implements a data merging operation received from at least two different data sources of said first set in order to consolidate the data used for detecting an obstacle.

5. The method as claimed in claim 1,
wherein the monitoring step (E1) comprises a second data receiving step (E1C) implemented for receiving position data of the aircraft and a data processing step (E1B) implemented for processing the position data received in the second data receiving step (E1C) so as to determine a position, called absolute position, of the aircraft and for comparing the absolute position of the aircraft with an absolute position of at least one fixed object of the aerodrome in order to detect, if applicable, a future collision with the fixed object representing an obstacle.

6. The method as claimed in claim 5,
wherein the second data receiving step (E1C) receives position data from at least one of the data sources of a second set, said second set comprising at least one of the following data sources of the aircraft:
an inertial reference system;
a satellite positioning system;
an odometer,
a tachometer, or
an optoelectronic sensor.

7. The method as claimed in claim 6,
wherein the data processing step (E1B) implements an operation of merging position data received from at least two different data sources of said second set for determining a consolidated absolute position of the aircraft.

8. The method as claimed in claim 1,
wherein the avoidance assistance step (E2) is implemented for emitting at least one of the following messages: a warning message, or a ground navigation assistance message, said message being transmitted in at least one of the following forms: visual, or audible.

9. The method as claimed in claim 1,
wherein the avoidance assistance step (E2) is implemented for forcing the aircraft into an automatic avoidance maneuver, at least in the absence of appropriate action by the pilot after the emission of at least one message.

10. A system for assisting the avoidance of a collision with an obstacle for an aircraft taxiing on an aerodrome, said system comprising:
a monitoring unit configured for monitoring the aerodrome so as to be able to detect at least one obstacle, for determining a current relative position and a current relative speed of the aircraft relative to the at least one detected obstacle, and for detecting a future collision of the aircraft with the at least one obstacle as a function of at least the current relative position and the current relative speed, the monitoring unit comprising a data processing device configured for determining at least one current warning envelope corresponding to a time, called collision time, and at least depending on said current relative position, on the current relative speed and on parameters of the aircraft, and for detecting a future collision with the at least one detected obstacle if the current warning envelope touches the at least one detected obstacle, the current warning envelope having a shape reproducing, in a simplified manner, a front part of an external contour of the aircraft (AC), and the current warning envelope is positioned in front of the aircraft at a corresponding distance; and
an avoidance assistance unit configured for, in the event of the detection of a future collision by the monitoring unit, implementing at least one action intended for assisting the avoidance of the future collision.

11. An aircraft comprising at least one system as claimed in claim 10.
